(19) United States
(12) Patent Application Publication
(10) Pub. No.: US 2026/0300012 A1
(43) Pub. Date: Oct. 1, 2026

(54) ACCELERATOR TO SELECT OPTIMAL KERNEL SOLUTION

(71) Applicant: Advanced Micro Devices, Inc., Santa Clara, CA (US)

(72) Inventors: Johannes Manfred DIETERICH, Austin, TX (US); Gurunath Anandrao KADAM, Austin, TX (US)

(21) Appl. No.: 19/096,502

(22) Filed: Mar. 31, 2025

(51) Int. Cl. G06F 9/50

(52) U.S. Cl. CPC G06F 9/5027; G06F 2209/501

(57) ABSTRACT

Embodiments herein describe an accelerator including circuitry configured to, during runtime, sample, using profiling circuitry, a kernel space including multiple kernels to evaluate the multiple kernels based on one or more quality metrics, identify an optimal kernel from the multiple kernels in the kernel space, and use the optimal kernel for a computation task selected by a user. The profiling circuitry monitors and analyzes how the multiple kernels behave during execution of the computation task.

### TECHNICAL FIELD

Examples of the present disclosure generally relate to accelerators, and, in particular, to an accelerator used to select an optimal kernel solution.

### BACKGROUND

Finding an optimal solution for a graphics processing unit (GPU) kernel involves selecting the implementation that maximizes performance, minimizes execution time, and/or optimally utilizes hardware resources. This process is of importance in, e.g., parallel computing, where GPUs are tasked with executing computationally intensive workloads like machine learning, scientific simulations, and data processing. However, GPU kernels, which are specialized functions to be executed on the GPU, come with a wide array of configurable parameters such as thread block sizes, memory access patterns, and synchronization strategies. Each of these parameters influences the GPU kernel’s performance and may vary during workload execution. The challenge lies in determining the most efficient configuration under real-time conditions while accounting for varying workload characteristics, hardware availability, and other system constraints such as power consumption and memory usage.

### SUMMARY

One example described herein is an accelerator including circuitry configured to, during runtime, sample, using profiling circuitry, a kernel space including multiple kernels to evaluate the multiple kernels based on one or more quality metrics, identify an optimal kernel from the multiple kernels in the kernel space, and use the optimal kernel for a computation task selected by a user.

One example described herein is a processor including profiling circuitry configured to sample multiple kernels of a kernel space to evaluate the multiple kernels on runtime behavior based on one or more quality metrics and kernel selector circuitry configured to identify an optimal kernel from the multiple kernels.

One example described herein is a method including providing a computation task to an accelerator, sampling, during runtime, a kernel space including multiple kernels to evaluate the multiple kernels based on one or more quality metrics, identifying an optimal kernel from the multiple kernels in the kernel space, and using the optimal kernel for the computation task selected by a user.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates an accelerator for selecting an optimal kernel solution, according to an example.

FIG. 1B illustrates the process flow for using the accelerator to select an optimal kernel solution, according to an example.

FIG. 1C illustrates sampling and profiling performed on kernels of the kernel space, according to an example.

FIG. 2 illustrates a flowchart for using the accelerator to select an optimal kernel solution, according to an example.

FIG. 3 is a block diagram of an accelerator unit (AU) configured to execute workloads for applications running on a processing system, according to an example.

FIG. 4 illustrates a practical application using the accelerator to select an optimal kernel solution, according to an example.

FIG. 5 illustrates a method for using the accelerator to select an optimal kernel solution, according to an example.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the examples herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Graphics processing units (GPUs) are used in accelerating computational workloads, especially for tasks that involve large-scale data processing, machine learning, and scientific simulations. One of the challenges in using GPU power lies in finding the optimal kernel configuration that maximizes performance. A GPU kernel is a parallel function executed on a GPU that is tailored for specific workloads. Since the performance of a GPU kernel is influenced by a variety of factors, such as thread block sizes, memory access patterns, synchronization strategies, and hardware resources, finding the best configuration can significantly reduce execution time and improve overall resource efficiency. However, due to the complex nature of the GPU architecture and the runtime variability of workloads, determining the optimal kernel configuration is no trivial task.

Existing solutions for finding the optimal GPU kernel configuration primarily focus on three approaches, that is, ahead-of-time/standalone kernel tuning, fast heuristic-based solution selection at runtime, and a combination of both. The ahead-of-time or standalone kernel tuning approach involves profiling and optimizing kernel configurations before runtime. This process aims to determine the best configuration for a specific workload or set of conditions, providing a solution that is pre-tuned for maximum performance. While this method can lead to performance gains for known workloads, it suffers from several drawbacks. Such approach involves substantial time and computational resources to optimize all possible solution kernels that may be encountered during runtime. Moreover, any offline-tuned kernels may not prove to be optimal when deployed in a live environment, as they fail to account for runtime variables such as noisy neighbors, available resources, and changing chip temperatures.

Heuristic-based solutions, on the other hand, attempt to select kernel configurations quickly during runtime based on a set of predefined rules or performance heuristics. This approach aims to reduce the overhead of profiling and tuning by applying fast approximations, with the goal of achieving good performance without the heavy computational cost of exhaustive kernel profiling. While this method can be effective for rapid selection, it does not always result in the optimal solution. The heuristic-based approach usually focuses on specific performance metrics, such as execution time, without considering all relevant variables, and fails to account for dynamic runtime conditions such as resource availability and thermal constraints. Additionally, since heuristics are based on a predefined set of rules, they may not adapt well to the full range of workload types and conditions encountered in GPU applications.

The combination approach, which integrates both ahead-of-time tuning and heuristic-based selection, seeks to balance the trade-offs between exhaustive kernel optimization and runtime performance prediction. While it can offer better results than using either method independently, it still faces limitations. The use of ahead-of-time tuning is still computationally expensive, and it often leads to non-optimal solutions under changing runtime conditions. Moreover, the reliance on heuristics for rapid selection may result in suboptimal performance when workload characteristics change unpredictably during execution. While these existing solutions strive to find the optimal kernel configuration, they do not fully address the inherent complexities of GPU workloads and the variability of runtime conditions.

To overcome these limitations, the examples present a dynamic three-part approach to finding the optimal GPU kernel configuration. The first part involves defining at least one quality metric that captures the desired performance characteristics of the workload or computation task. This may include execution time, throughput, memory utilization, and/or energy efficiency, depending on the nature of the workload and the priorities of the system. By defining a comprehensive quality metric, a clear benchmark is established for comparing different kernel configurations.

The second part involves sampling the kernel space. During runtime, the quality metric is used to profile and evaluate a set of existing kernel configurations. This can be performed through the process of sampling, where different kernel configurations are tested under real-time conditions to assess their performance against the defined metric. Leveraging, e.g., hardware counters and lightweight timing functionality, the sampling process allows the capture of performance data quickly without introducing significant overhead. This ensures that the kernel configurations are evaluated based on actual runtime behavior, taking into account the specific conditions of the system and workload.

The third part involves selecting the optimal kernel configuration for execution based on the performance data gathered during the sampling phase. This approach allows the system to dynamically adapt to changing conditions and select the most effective kernel configuration for the current workload. By continuously monitoring the quality metric and kernel performance, the system can adjust the configuration as needed, ensuring that the optimal kernel is used for the entire duration of the workload. This approach strikes a balance between pre-tuned solutions and runtime adjustments, providing a flexible and adaptive method for kernel optimization.

The proposed three-part approach offers several advantages over existing solutions. First, it eliminates the need for exhaustive ahead-of-time kernel optimization, reducing both the computational cost and time investment needed. Second, it mitigates the shortcomings of heuristic-based approaches by relying on real-time profiling to select the best configuration for the current conditions. Finally, by incorporating dynamic runtime adjustments, this approach ensures that the selected kernel configuration remains optimal throughout the entire workload, adapting to changes in resource availability, thermal conditions, and workload characteristics.

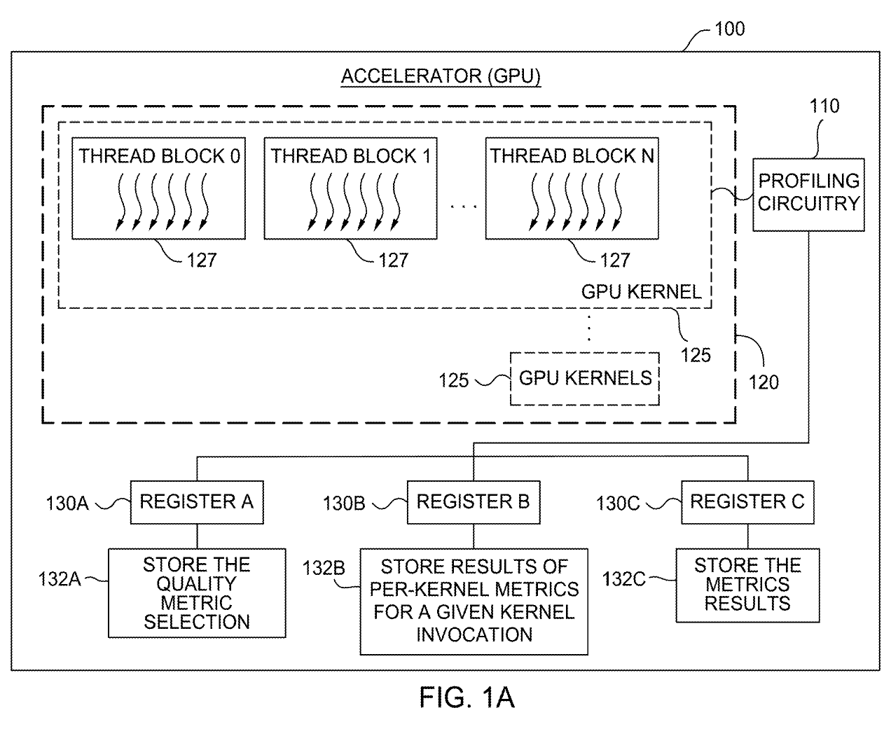

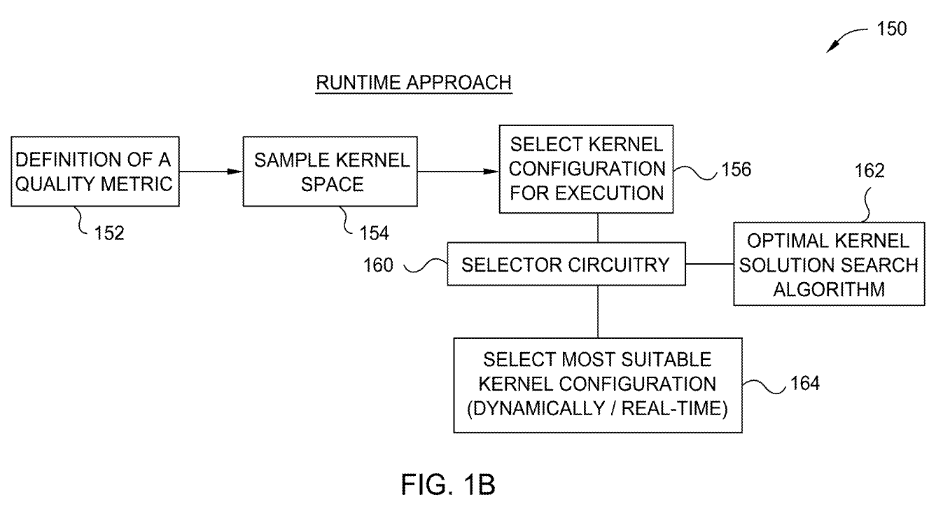

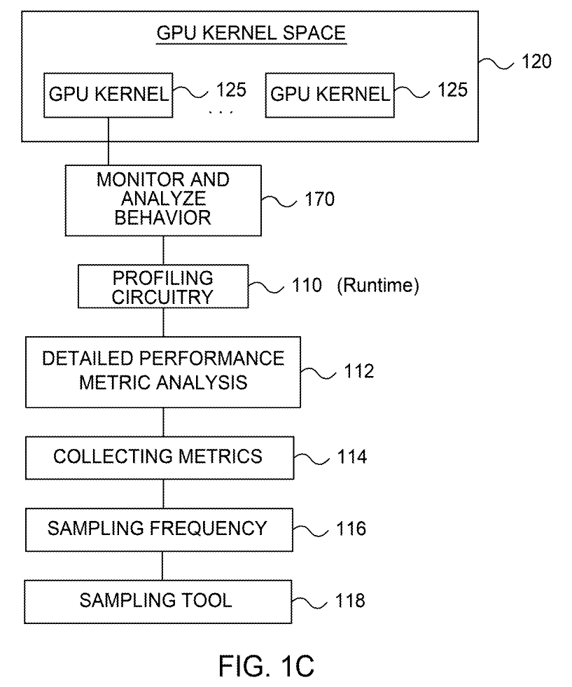

FIG. 1A illustrates an accelerator for selecting an optimal kernel solution, according to an example.

The accelerator 100 is specialized hardware for speeding up computations by offloading tasks from a central processing unit (CPU). The accelerator 100 can improve performance and energy efficiency, especially for workloads that involve high levels of parallelism. One type of accelerator can be a GPU. The accelerator 100 can process the GPU kernels 125 of a GPU kernel space 120. The GPU kernel space 120 is distinct from the user space, where applications are run.

The GPU kernel space 120 refers to the memory space and environment in which GPU kernels 125 execute. The GPU kernel space 120 is an abstraction that allows the kernel to run on the GPU while ensuring that the GPU has access to the resources it needs (e.g., memory, registers, execution context). The GPU kernel space 120 includes the global memory, shared memory, and local memory of the GPU. These memory spaces are used by threads 127 to store data during the kernel’s execution.

The GPU kernel 125 is a function executed by many parallel threads on the GPU. The GPU kernel 125 can be written using a programming model. Stated differently, the GPU kernel 125 is a function that performs a specific computation, such as matrix multiplication, image processing, or neural network operations. When the kernel is launched on the GPU, the computation is split into many smaller tasks (the threads 127), which are executed concurrently on the GPU’s thousands of cores. The GPU kernel 125 operates on many threads in parallel, where each thread performs the same operation but on different data. Each thread within a kernel runs on a different core of the GPU, leveraging the massive parallel processing power of the GPU.

Each GPU kernel 125 includes threads 127. In GPU programming, the kernel refers to a function that is executed on the GPU by a massively parallel set of threads. The GPU kernel 125 is written to perform the same computation on different pieces of data in parallel (e.g., processing each element of an array independently). Each thread 127 in the GPU kernel 125 executes the same instructions, but operates on different data. As such, the GPU kernel 125 is a function or program executed on the GPU. When a kernel is launched, it is run on thousands (or millions) of threads in parallel. A GPU kernel 125 is usually launched by specifying the number of blocks and threads per block, and each thread within a block executes the same kernel function. The thread 127 is an individual unit of execution that performs a specific task (such as adding two elements in an array) within the GPU kernel 125. Each thread 127 runs in parallel with others in a block, and multiple blocks can be used to handle larger datasets.

Profiling circuitry 110 is used to process the GPU kernels 125. Profiling refers to the in-depth analysis of kernel execution during runtime, involving a collection of detailed performance data to understand how various factors (such as memory access patterns, thread distribution, etc.) influence performance. Profiling circuitry 110 is used to analyze the performance of a GPU kernel 125 by sampling execution metrics instead of capturing every execution instance. In other words, instead of capturing all executions of a GPU kernel 125 (which may run in the millions of times), sampling-based profiling randomly or periodically selects a subset of executions (e.g., 10 or 20 times out a million). Sampling-based profiling may also record performance data such as execution time, memory access patterns, and instruction counts.

Data processed by the profiling circuitry 110 may be stored in a number of registers. In one non-limiting example, three registers are provided. A first register A (130A) for storing a quality metric selection 132A, a second register B (130B) for storing results of per-kernel metrics 132B for a given kernel invocation, and a third register C (130C) for storing the metric results 132C. The per-kernel metrics are execution-specific performance data for a particular GPU kernel invocation. These metrics provide real-time insight into how the GPU kernel performs during execution. The first register 130A may store quality metric selection, allowing the system to dynamically choose which performance metrics to track. This enables real-time profiling adjustments based on workload characteristics. The second register 130B may store pre-kernel execution metrics. The second register 130B may be optional. In one example, the first register 130A and the second register 130B may be combined into one single register. The third register 130C stores post-execution metric results, enabling comparison with pre-kernel data. The first register 130A may be programmed via runtime drivers, whereas the second register 130B and the third register 130C may be programmed during runtime based on the first register’s 130A configuration.

The example approach is a hardware-software co-designed approach that can dynamically select the optimal kernel configuration at runtime, including launch parameters (e.g., precision, execution mode, memory access strategy). This method adapts to real-world constraints (power, temperature, resource contention) and ensures efficient execution.

FIG. 1B illustrates the process flow for using the accelerator to select an optimal kernel solution, according to an example.

The process flow 150 includes defining a quality metric in operation 152, sampling the kernel space in operation 154, and selecting a kernel configuration for execution in operation 156. The optimal kernel configuration is selected using selector circuitry 160 run by an optimal kernel solution search algorithm 162. The selector circuitry 160 selects the most suitable or optimal kernel configuration 164. The optimal kernel solution search algorithm 162 can identify and select the most efficient GPU kernel for executing a given computation task. This may involve profiling, ranking, and selecting the best or optimal kernel based on runtime performance metrics.

Regarding the operation 152, a quality metric quantifies the desirability of a kernel configuration. The quality metric guides the selection process based on optimization objectives. Optimization objectives may include minimizing execution time (latency), maximizing throughput (operations per second), minimizing power consumption, reducing memory bandwidth pressure, and balancing resource utilization. The quality metric is not fixed. Instead, it adapts dynamically based on runtime conditions. In one example, if memory congestion is high, kernels that reduce memory bandwidth usage may be prioritized.

Kernel configurations (or kernel variants) refer to different versions or setups of the same GPU kernel, each with distinct parameters or optimizations designed to improve performance based on various factors like available hardware, workload size, memory usage, or performance targets. These configurations or variants can vary in terms of execution parameters, memory management strategies, and algorithmic changes within the kernel code. An example of a kernel configuration may relate to thread block size, which is the number of threads per block. The block size is a parameter that affects how well the kernel can utilize the GPU’s resources, such as registers, shared memory, and execution units. Example configurations may include 256 threads per block, 512 threads per block, or 1024 threads per block. Larger block sizes can help increase parallelism but may lead to inefficient resource usage if the block size is too large for the kernel’s problem size or hardware limits.

Stated differently, a quality metric or optimization target is a measurable aspect of kernel performance that is used to assess the effectiveness of a kernel’s execution and guide optimizations. The quality metrics help in understanding how well a GPU kernel is performing under various conditions and how it can be improved. Optimization targets define the specific goals a developer wants to achieve, such as maximizing speed, minimizing memory usage, or improving throughput.

One quality metric is the execution time (latency), which is the total time taken by the kernel to execute on the GPU. Minimizing execution time is a key optimization target, as faster execution leads to better overall performance, especially for compute-heavy applications like machine learning. Optimizing execution time involves strategies like increasing thread parallelism, reducing thread divergence and minimizing memory latency (e.g., optimizing memory access patterns).

Another quality metric is throughput, which is the amount of work the kernel can handle per unit of time, typically measured in operations per second (e.g., floating-point operations per second). Maximizing throughput allows the kernel to process more data concurrently and faster. Maximizing throughput involves maximizing parallelism (more threads or blocks) and optimizing data movement to avoid bottlenecks.

Another quality metric is memory usage (bandwidth), which is the amount of memory used by the kernel during execution, including global, shared, and local memory. Efficient memory usage ensures that the GPU’s limited memory resources are effectively utilized, preventing performance degradation due to memory bottlenecks. Memory bandwidth (how quickly data can be transferred) is also a key performance factor. Optimizations can include reducing memory footprint, using shared memory or local memory effectively, and minimizing global memory accesses and optimizing access patterns to reduce latency.

Another quality metric is thread divergence, which occurs when threads in the same warp follow different execution paths, which can lead to performance losses because the GPU needs to serialize divergent threads. Reducing thread divergence minimizes the execution time spent handling divergent threads and ensures better parallelization. Optimizations may include rewriting the kernel to avoid conditional branches within warps and ensuring all threads in a warp execute the same path as much as possible.

Another quality metric is power consumption, which, in one example, is how well the kernel utilizes various levels of memory caches (L1, L2, shared memory) on the GPU to speed up memory access. Efficient caching reduces memory access latency and bandwidth consumption by minimizing the number of global memory accesses. Optimization techniques include ensuring data locality (using shared memory for frequently accessed data) and reducing cache misses by improving memory access patterns. Further, in another example, power consumption is influenced by cache utilization. Efficient cache usage reduces the frequency of accesses to off-chip memory, which is more power intensive than on-chip cache. When a kernel solution exhibits high cache locality, the number of cache hits increases, leading to fewer memory accesses. This results in lower power consumption since off-chip memory transactions involve higher energy costs due to, e.g., longer data transfer paths. Optimizing the kernel selection based on cache-aware power consumption metrics ensures that the accelerator operates with reduced energy overhead while maintaining high performance.

Another quality metric is load balancing, which is the degree to which the workload is evenly distributed across the available threads. Poor load balancing leads to some threads being idle while others are overburdened, which negatively impacts overall performance. Optimization strategies include ensuring threads are assigned equal amounts of work and using dynamic work distribution for irregular or unbalanced computations.

Regarding the operation 154, the system samples the kernel space, which includes all possible configurations for execution. Instead of testing all configurations, the system intelligently explores the search space using exploration and exploitation. Exploration refers to identifying a diverse set of candidate configurations and exploitation refers to focusing on configurations that historically performed well.

Stated differently, sampling the kernel space during runtime refers to the process of evaluating different kernel configurations (or kernel variants) on the fly to determine which one best meets the desired quality metrics (e.g., execution time, memory usage, throughput, etc.). This process uses available profile counters and lightweight kernel timing functions to measure the performance of various kernel configurations without incurring a significant overhead.

As such, sample-based profiling refers to a profiling method where the system periodically samples the execution state of the GPU kernels to collect performance insights. The profiling circuitry 110 interrupts execution at regular intervals (or random intervals) to capture snapshots of GPU kernel execution. The snapshots may include program counters of active threads, memory access patterns, execution latency, and register utilization. Multiple samples may be collected and aggregated to identify frequent execution paths or stall points in the GPU kernel.

The GPU kernel space 120 represents all possible kernel configurations, which can include various optimizations such as number of threads per block, number of blocks per grid, shared memory usage, memory access patterns, and specializations in the kernel code (e.g., different implementations of the same algorithm). The GPU kernel space 120 is large and multi-dimensional, as there can be many possible configurations depending on the hardware and problem size.

The advantages of sampling the GPU kernel space 120 at runtime include dynamic optimization, minimal overhead, no precomputation needed, and scalability. The system can adapt to changing conditions in real-time, making it possible to achieve optimal performance even under variable loads or hardware conditions. Using profile counters and lightweight timing functionality ensures that the overhead of sampling kernel configurations is low, allowing the system to make decisions without negatively impacting overall performance. Unlike static approaches (e.g., ahead-of-time tuning), this method does not involve precomputing the best configuration for all possible workloads or runtime conditions, which can be time-consuming and resource-intensive. This method can be applied to a large number of kernel configurations and can scale with complex, highly parallel workloads that need fine-tuned optimization.

Regarding operation 156, after sampling, the system chooses the best kernel configuration to execute based on the quality metric. The system may select the kernel configuration that maximizes a quality metric, apply hardware-aware constraints (e.g., avoid overheating, minimize power draw), and/or dynamically adjust launch configurations (thread block size, precision mode, dataflow selection).

The benefits of this three-part approach include the system adapting to real-time conditions (e.g., power, memory congestion, thermal constraints), minimizing execution time while balancing resource utilization, reducing kernel tuning overhead (no need to pre-optimize all possible configurations), and ensuring optimal performance per execution, not just statically optimized performance.

FIG. 1C illustrates sampling and profiling performed on kernels of the kernel space, according to an example.

The GPU kernel space 120 includes multiple GPU kernels 125. In operation, the GPU kernels 125 are launched from the CPU. The host (CPU) launches the kernel with specific parameters, including the number of threads and blocks to be executed on the GPU. The GPU organizes the threads into blocks (or groups of threads). Each block is assigned to a multiprocessor on the GPU. The threads within a block can share data using shared memory. Blocks are organized into a grid for execution. Each thread accesses different parts of the GPU memory (e.g., global memory, shared memory). The efficient use of these different memory types is valuable for maximizing performance. Once launched, the GPU kernel 125 is executed across all threads in parallel, where each thread works on a portion of the data. The threads within a block may synchronize, but each block is executed independently of others.

To identify the optimal kernel and use it until workload completion, a series of steps may be followed to dynamically find the best kernel configuration for the current workload and hardware conditions. In one example, a behavior analyzer 170 may be used, which includes circuitry to monitor and analyze GPU kernel behavior. The behavior analyzer 170 can track and record various aspects of GPU kernel execution. The behavior analyzer 170 may perform several different functions, such as performance profiling, memory analysis, thread divergence detection, power and thermal monitoring, and assessment of synchronization overhead.

Performance profiling may involve identifying hotspots, latency issues, and inefficient execution patterns. Memory analysis may involve monitoring cache misses, shared memory conflicts, and global memory access patterns. Thread divergence detection may involve identifying warp-level execution inefficiencies. Power and thermal monitoring may involve measuring power consumption and identifying thermal throttling points. The behavior analyzer 170 may include or cooperate with various hardware components to perform such functions. Such hardware may include, but is not limited to, performance counters, hardware tracing units, debugging circuits, and ring buffers for event logging.

The behavior analyzer 170 can communicate with the profiling circuitry 110. The profiling circuitry 110 executes detailed performance metric analysis 112, performs metric collection 114, indicates sampling frequency 116, and uses sampling tools 118.

The profiling circuitry 110 collects execution metrics by sampling kernel execution at periodic intervals or random intervals (e.g., the sampling frequency 116). This sampled-based profiling mechanism enables efficient performance analysis without excessive overhead. The purpose of the profiling circuitry 110 is to gather execution metrics to identify performance bottlenecks in GPU kernels, optimize memory access patterns, cache utilization, and thread execution, reduce power consumption by detecting inefficient execution units, monitor compute unit (CU) utilization, and execution stalls, and provide real-time feedback for adaptive runtime optimization. Unlike event-based profiling, which records every execution event (leading to high overhead), sample-based profiling periodically captures a snapshot of the system state, allowing lower-overhead monitoring.

Profiling circuitry 110 may include sampling triggers, execution metric collection (e.g., the metric collection 114), aggregation, processing, data export, and analysis. Hardware counters generate interrupts at periodic intervals. Time-based or event-based triggers determine when to capture execution snapshots. The profiling circuitry 110 can also capture program counters, register states, memory access details, and pipeline status. The profiling circuitry 110 can also sample warp execution, instruction latency, and cache behavior. Sampled data may be stored in on-chip ring buffers or profiling registers. The behavior analyzer 170 processes the collected data and identifies trends. The profiler transfers sampled data to software tools (e.g., the sampling tools 118, which may be the AMD ROCm profiler) for further analysis. Post-processing tools visualize execution hotspots and inefficiencies.

As such, the profiling circuitry 110 and the behavior analyzer 170 work together to monitor, analyze, and optimize GPU kernel execution by capturing real-time performance metrics and identifying inefficiencies.

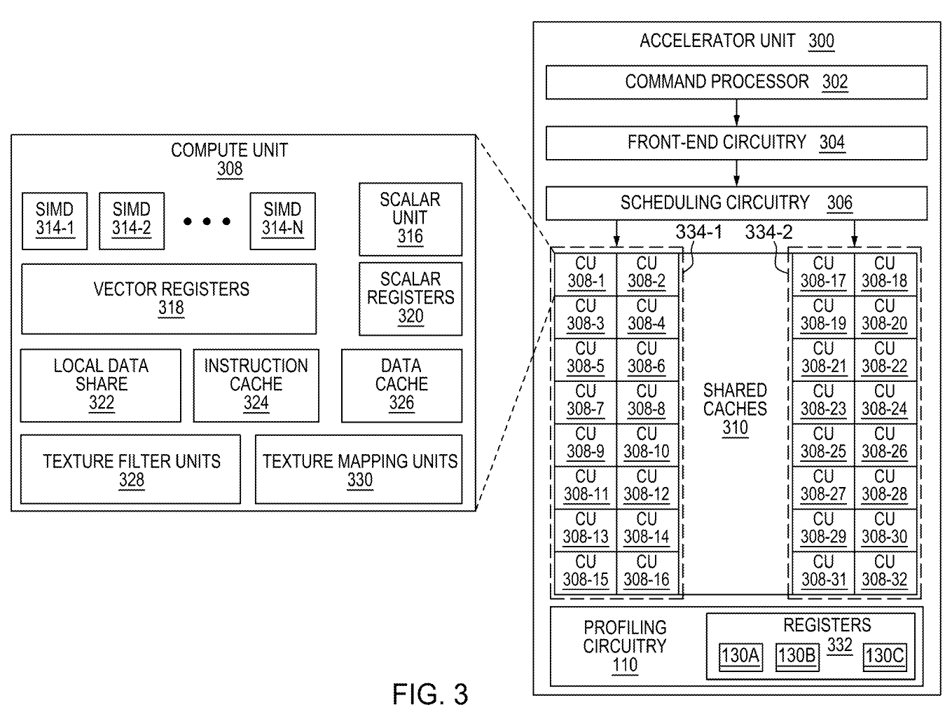

The profiling circuitry 110 is incorporated in the accelerator unit 300 (FIG. 3). The profiling circuitry 110 may include different hardware components, such as, but not limited to, performance counters, program counters, sampling timers and triggers, ring buffers for data storage, profiling interrupt handlers, and hardware debugging and tracing units. The profiling circuitry 110 can offer several benefits, such as low overhead performance monitoring, identifying memory bottlenecks, tracking compute utilization, and debugging support for kernel behavior.

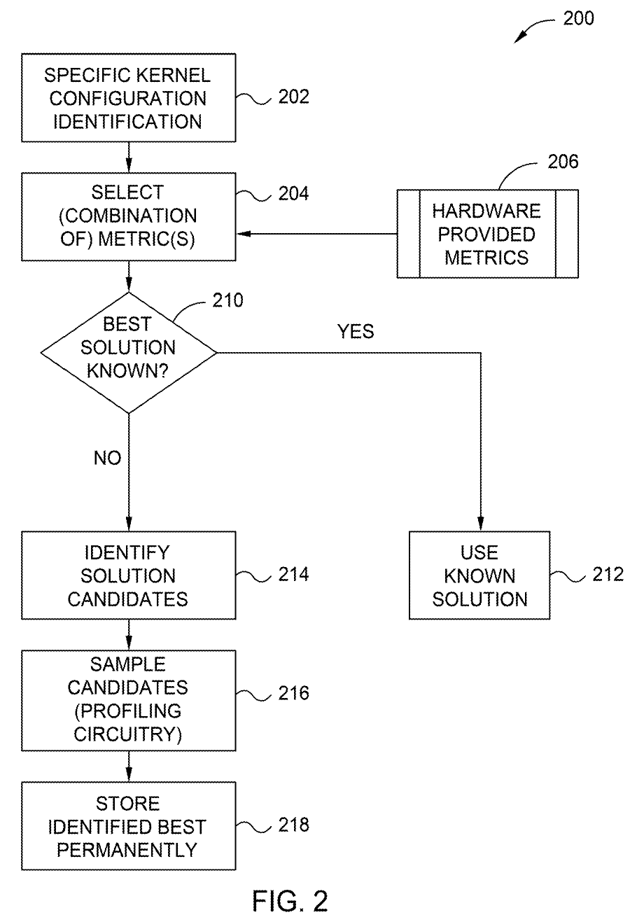

FIG. 2 illustrates a flowchart 200 for using the accelerator to select an optimal kernel solution, according to an example.

At 202, specific kernel configuration identification is performed. Kernel configuration identification refers to the process of extracting and analyzing the configuration parameters of a GPU kernel during execution. The purpose of the kernel configuration identification includes optimizing thread-block distribution and grid size, identifying register and shared memory bottlenecks, detecting warp inefficiencies, improving memory and cache utilization, and reducing stall cycles due to poor execution configuration.

At 204, quality metrics are selected. First, the term “optimal” is defined. An optimal kernel is one that achieves the best balance of performance, resource utilization, and power efficiency for a given workload or computation task. The optimal kernel is a user-definable quantity, and is not fixed or static. The optimal kernel selection depends on, e.g., hardware constraints, workload characteristics, and user-defined performance goals. Different users or workloads may prioritize different aspects. Some may seek to minimize latency, while others may seek to focus on power consumption. As such, the definition of “optimal” is adaptable, where the kernel is selected based on dynamically weighted metrics rather than a single static criterion.

A kernel may be considered optimal when it maximizes throughput, minimizes execution time, maximizes GPU resource utilization, minimizes bottlenecks or optimizes energy efficiency. For example, if the workload or computation task is matrix multiplication, the optimal kernel strategy may be to use a GPU kernel that utilizes thread tiling, shared memory, and register blocking. If the workload or computation task is a deep learning inference, then the optimal kernel strategy may be to use a GPU kernel that keeps latency below a target while minimizing power consumption. Common metrics include execution time, throughput, memory usage, and energy consumption. Depending on the nature of the workload or computation task, one or more of these metrics may need to be minimized.

At 206, hardware provided metrics may be used to select one or more quality metrics. Hardware quality metrics help assess performance, efficiency, and bottlenecks in GPU execution. These metrics are provided by hardware counters, sampling circuits, and profiling tools. For example, an execution efficiency metric may be used to measure how effectively the GPU cores are used. A memory efficiency metric may be used to evaluate memory access patterns and caching effectiveness. A power consumption metric may be used to help optimize for power-efficient computation.

At 210, it is determined if the best solution is known. If YES, the process proceeds to 212. If NO, the process proceeds to 214.

At 212, the optimal kernel solution is known. The optimal GPU kernel for a given workload may be known beforehand based on, e.g., predetermined configurations, historical execution data, auto-tuning techniques (e.g., machine learning), or architectural constraints. Thus, some optimal kernel configurations are determined based on well-known algorithms, hardware specifications, and empirical testing. Some optimal kernel configurations are determined based on past execution logs. Therefore, in certain instances, the optimal kernel can be predefined, learned from historical data, or auto-tuned dynamically.

At 214, if the optimal kernel solution is not known, then kernel solution candidates are identified. The optimal kernel solution candidates can be identified using profiling, hardware utilization analysis, algorithmic complexity evaluation, auto-tuning and machine learning search, or predictive modeling using historical data. In other words, GPU kernels can be identified based on runtime performance metrics, hardware efficiency maximization, best algorithmic efficiency, by dynamically exploring multiple kernel configurations, and by GPU architecture optimization. At 214, if the optimal kernel solution is not known, then kernel solution candidates are identified. These kernel solution candidates can be identified using sampling profiling targeting execution time, hardware utilization analysis, algorithmic complexity evaluation, auto-tuning and machine learning search, or predictive modeling using historical data. In other words, possible GPU kernels can be identified based on runtime performance metrics, hardware efficiency maximization, best algorithmic efficiency, by dynamically exploring multiple kernel configurations, and by GPU architecture optimization.

At 216, candidate GPU kernels are sampled using the profiling circuitry 110. The profiling circuitry 110 samples execution metrics during runtime. The profiling circuitry 110 collects performance samples at specific intervals, instead of tracking every operation, in order to minimize profiling overhead. The sampled data provides insights into compute efficiency, memory access patterns, instruction throughput, and processor utilization. The profiling circuitry 110 may rank and refine GPU kernel candidates for different workloads. By sampling such data, the profiling circuitry 110 can identify bottlenecks. This information can be used to determine an optimal GPU kernel that best uses GPU resources for a specific workload.

At 218, the optimal kernel solution is stored in an optimal kernel solution storage. This may be a dedicated kernel repository that enables efficient retrieval and reuse. When a new workload is executed, the system can query the storage repository for past kernel solutions matching the workload parameters. The system can then select the best or optimal kernel candidate based on profiling metrics, historical performance, and GPU architectural compatibility. The selected optimal kernel solution may then be loaded into the GPU runtime for immediate execution, minimizing launch overhead. The storage and retrieval system enables efficient GPU kernel execution, reducing redundant profiling, and ensuring the highest performance for repeated or similar workloads.

FIG. 3 is a block diagram of an accelerator unit (AU) configured to execute workloads for applications running on a processing system, in accordance with some examples.

FIG. 3 presents an AU 300 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 300. To perform these workgroups, AU 300 includes one or more vector processors, coprocessors, graphics processing units (GPUs), general-purpose GPUs, non-scalar processors, highly parallel processors, artificial intelligence (AI) processors, inference engines, AI engines, AI engine cores, machine-learning processors, or any combination thereof. As an example, AU 300 includes one or more command processors 302, front-end circuitry 304, scheduling circuitry 306, compute units 308, shared caches 310, and profiling circuitry 110.

A command processor 302 of AU 300 is configured to receive, from the CPU, a command stream indicating one or more workgroups to be executed. As an example, based on a compute application running on the processing system, the command processor 302 receives a command stream indicating workgroups that involve compute operations such as matrix multiplication, addition, subtraction, and the like to be performed. As another example, based on a graphics application running on the processing system, the command processor 302 receives a command stream indicating workgroups that include draw calls for a scene to be rendered. After receiving a command stream, the command processor 302 parses the command stream and issues respective instructions of the indicated workgroups to front-end circuitry 304, scheduling circuitry 306, or both. As an example, based on a command stream from a graphics application, the command processor 302 issues one or more draw calls to front-end circuitry 304 that includes one or more vertex shaders, polygon list builders, and the like. From the instructions issued from the command processor 302, front-end circuitry 304 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 302, front-end circuitry 304 determines a list of primitives to be rendered for a scene. After determining a list of primitives to be rendered for a scene, the front-end circuitry 304 issues one or more draw calls (e.g., a workgroup) associated with the primitives in the list of primitives to scheduling circuitry 306.

Based on the instructions of the workgroups received from a command processor 302, front-end circuitry 304, or both, scheduler circuitry 306 is configured to provide data indicating threads (e.g., operations for these threads) to be executed for these workgroups to one or more compute units 308. Each compute unit 308 is configured to support the concurrent execution of two or more threads of a workgroup. For example, each compute unit 308 is configured to concurrently execute a predetermined number of threads referred to herein as a “wavefront.” Based on the size of the wavefront of a compute unit 308, scheduler circuitry 306 schedules one or more groups of threads of the workgroup, also referred to herein as “waves,” to be executed by the compute unit 308. As an example, scheduler circuitry 306 first updates one or more registers of a compute unit 308 such that the compute unit 308 is configured to execute a first group of waves of the workgroup. After the compute unit 308 has executed the first group of waves, scheduler circuitry 306 updates one or more registers of the compute unit 308 to schedule a second group of waves of the workgroup to be executed by the compute unit 308. To execute these waves, each compute unit is connected to one or more shared caches 310 that each include a volatile memory, non-volatile memory, or both accessible by one or more compute units 308. These shared caches 310, for example, are configured to store data (e.g., register files, values, operands, instructions, variables) used in the execution of one or more waves, data resulting from the performance of one or more waves, or both. Because a shared cache 310 is accessible by two or more compute units 308, a first compute unit 308 is enabled to provide results from the execution of a first wave to a second compute unit 308 executing a second wave. Though the examples presented in FIG. 3 shows AU 300 as including 32 compute units (308-1 to 308-32), in other implementations, AU 300 can include any number of compute units 308.

Each compute unit 308 includes one or more single instruction, multiple data (SIMD) units 314, a scalar unit 316, vector registers 318, scalar registers 320, local data share 322, instruction cache 324, data cache 326, texture filter units 328, texture mapping units 330, or any combination thereof. A SIMD unit 314 (e.g., a vector processor) is configured to concurrently perform multiple instances of the same operation for a wave. For example, a SIMD unit 314 includes two or more lanes each including an arithmetic logic unit (ALU) and each configured to perform the same operation for the threads of a wave. Though the examples presented in FIG. 3 shows a compute unit 308 including three SIMD units (314-1, 314-2, 314-N) representing an N number of SIMD units, in other implementations, a compute unit 308 can include any number of SIMD units 314. Further, as an example, the size of a wavefront supported by AU 300 is based on the number of SIMD units 314 included in each compute unit 308. To determine the operations performed by the SIMD units 314, each compute unit 308 includes vector registers 318 formed from one or more physical registers of AU 300. These vector registers 318 are configured to store data (e.g., operands, values) used by the respective lanes of the SIMD units 314 to perform a corresponding operation for the wave. Additionally, each compute unit 308 includes a scalar unit 316 configured to perform scalar operations for the wave. As an example, the scalar unit 316 includes an ALU configured to perform scalar operations. To support the scalar unit 316, each compute unit 308 includes scalar registers 320 formed from one or more physical registers of accelerator unit 300. These scalar registers 320 store data (e.g., operands, values) used by the scalar unit 316 to perform a corresponding scalar operation for the wave.

Further, each compute unit 308 includes a local data share 322 formed from a volatile memory (e.g., random-access memory) accessible by each SIMD unit 314 and the scalar unit 316 of the compute unit 308. That is to say, the local data share 322 is shared across each wave concurrently executing on the compute unit 308. The local data share 322 is configured to store data resulting from the execution of one or more operations for one or more waves, data (e.g., register files, values, operands, instructions, variables) used in the execution of one or operations for one or more waves, or both. As an example, the local data share 322 is used as a scratch memory to store results necessary for, aiding in, or helpful for the performance of one or more operations by one or more SIMD units 314. The instruction cache 324 of a compute unit 308, for example, includes a volatile memory, non-volatile memory, or both configured to store the instructions to be executed for one or more waves to be executed by the compute unit 308. Further, the data cache 326 of a compute unit 308 includes a volatile memory, non-volatile memory, or both configured to store data (e.g., register files, values, operands, variables) used in the execution of one or more waves by the compute unit 308. The instruction cache 324, data cache 326, shared caches 310, and a system memory, for example, are arranged in a hierarchy based on the respective sizes of the caches. As an example, based on such a cache hierarchy, a compute unit 308 first requests data from a controller of a corresponding data cache 326. Based on the data not being in the data cache 326, the data cache 326 requests the data from a shared cache 310 at the next level of the cache hierarchy. The caches then continue in this way until the data is found in a cache or requested from the system memory, at which point, the data is returned to the compute unit 308. Additionally, each compute unit 308 includes one or more texture mapping units 330 each including circuitry configured to map textures to one or more graphics objects (e.g., groups of primitives) generated by the compute units 308. Further, each compute unit 308 includes one or more texture filter units 328 each having circuitry configured to filter the textures applied to the generated graphics objects. For example, the texture filter units 328 are configured to perform one or more magnification operations, anti-aliasing operations, or both to filter a texture.

Additionally, to help perform instructions for one or more workgroups, AU 300 includes profiling circuitry 110. Such profiling circuitry 110 includes hardware (e.g., fixed-function hardware) configured to execute one or more instructions for one or more workgroups. As an example, profiling circuitry 110 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 306 is configured to update one or more physical registers 332 of AU 300 associated with the hardware. The registers 332 may include the first register A (130A) for storing a quality metric selection 132A, the second register B (130B) for storing results of per-kernel metrics 132B for a given kernel invocation, and the third register C (130C) for storing the metric results 132C.

In some cases, AU 300 includes one or more compute units 308 grouped into one or more shader engines 334. Referring to the implementation presented in FIG. 3, for example, AU 300 includes compute units 308-1 to 308-16 grouped in a first shader engine 334-1 and compute units 308-17 to 308-32 grouped in a second shader engine 334-2. Such shader engines 334, for example, are configured to execute one or more workgroups (e.g., one or more compute kernels) for an application and include one or more compute units 308, graphics processing hardware (e.g., primitive assemblers, rasterizers), one or more shared caches 310, render backends, or any combination thereof. Though the example presented in FIG. 3 shows AU 300 as including two shader engines (334-1, 334-2), in other implementations, AU 300 can include any number of shader engines (334-1, 334-2).

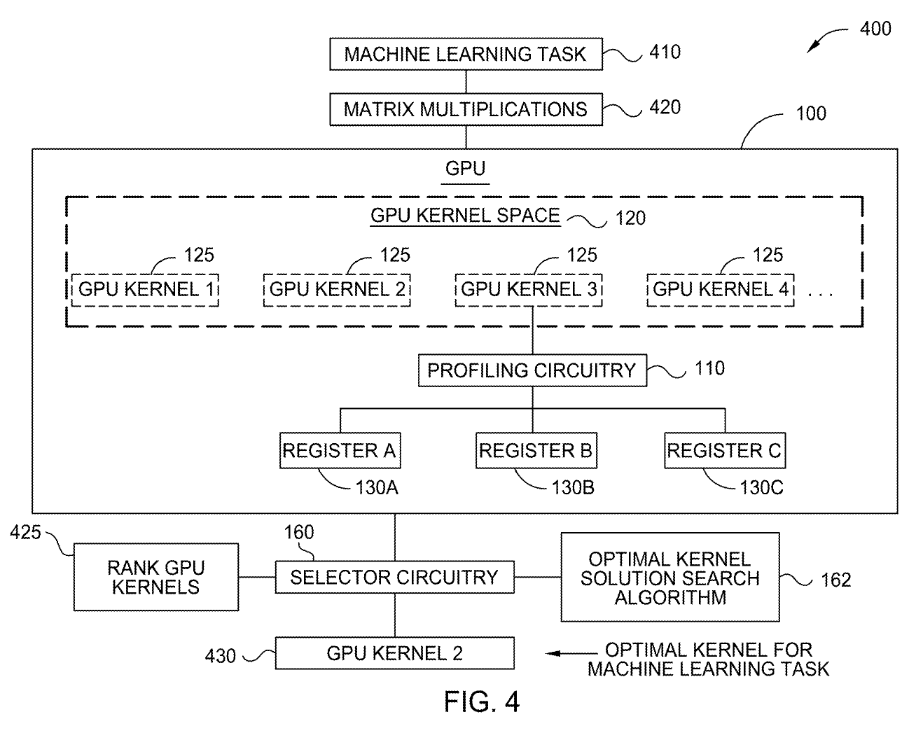

FIG. 4 illustrates a practical application 400 using the accelerator to determine an optimal kernel solution, according to an example.

In one example, a task may be a machine learning task 410. The machine learning task 410 may be a specific prediction or inference that a machine learning model is trained to perform based on patterns in the data. Such task may be a classification task or regression task or clustering task. In one example, the machine learning task 410 may involve matrix multiplications 420. A machine learning task that relies on the matrix multiplications 420 is neural network training. In neural network training, forward and backward propagation steps involve multiple matrix multiplications to calculate the activation values at each layer of the neural network. The machine learning task 410 involving the matrix multiplications 420 may be sent to the accelerator 100. The accelerator 100 may be a GPU. The accelerator 100 may be the accelerator unit 300 of FIG. 3.

The accelerator 100 includes the GPU kernel space 120 having the GPU kernels 125. The GPU kernels 125 are evaluated using the profiling circuitry 110. In operation, the accelerator 100 needs to select the best or optimal GPU kernel from the GPU kernel space 120. The optimal kernel configuration ensures that the accelerator 100 operates at peak efficiency when processing the machine learning task 410.

The first step is to define a quality metric that reflects the desired performance goals. This may include metrics such as execution time, throughput, memory bandwidth utilization, energy consumption, or latency. The quality metric serves as a benchmark for evaluating different kernel configurations. The quality metric provides a concrete measure of performance that helps in comparing and selecting the optimal configuration. In the instant case, the quality metric for the machine learning task 410 may be accuracy or predictive power of the model, as the goal may be to achieve the most accurate predictions possible, even if it means slightly longer processing time.

The second step is to sample the GPU kernel space 120, during runtime, which involves testing different kernel configurations under real-time conditions to gather performance data. Kernel configurations include parameters such as thread block size (e.g., number of threads per block), memory access patterns (e.g., how global, shared, and local memory is utilized), and thread synchronization mechanisms (e.g., how threads are synchronized within a block). The system executes these configurations and collects performance data (such as execution time, memory usage, and other relevant metrics) using hardware counters or timing functionality. Sampling using the profiling circuitry 110 allows for evaluating different kernel configurations without significantly impacting overall performance.

Data processed by the profiling circuitry 110 may be stored in a number of registers. In one non-limiting example, three registers are provided. The first register A (130A) for storing a quality metric selection 132A, the second register B (130B) for storing results of per-kernel metrics 132B for a given kernel invocation, and the third register C (130C) for storing the metric results 132C. The first register 130A stores quality metric selection, allowing the system to dynamically choose which performance metrics to track. This enables real-time profiling adjustments based on workload characteristics. The second register 130B stores pre-kernel execution metrics. The second register 130B may be optional. In one examples, the first register 130A and the second register 130B may be combined into a single register. The third register 130C stores post-execution metric results, enabling comparison with pre-kernel data. As such, any number of registers may be implemented to store various types of data. The use of two or three registers in the examples are merely non-limiting implementations.

Once the profiling circuitry 110 has analyzed the GPU kernels based on the received workload (e.g., machine learning task 410), the selector circuitry 160 uses an optimal kernel solution search algorithm 162 to determine the optimal GPU kernel for the machine learning task 410. In one example, the selector circuitry 160 may select the second GPU kernel 430 as the optimal GPU kernel for the machine learning task 410. Thus, once the optimal configuration is identified, it is used for executing the machine learning task 410. In some cases, this selection process may involve additional refinements or adjustments based on hardware state changes (e.g., temperature fluctuations or resource contention).

As the GPU kernel executes, continuous monitoring ensures that the optimal configuration remains suitable for the current workload and runtime conditions. If performance degradation is detected or if resource conditions change (e.g., the GPU temperature increases or memory pressure rises), the system may revisit the profiling and selection steps to re-evaluate and adjust the kernel configuration. This dynamic adaptation ensures that the system continuously operates at peak efficiency, even under changing workload characteristics or hardware constraints.

In one example, the selector circuitry 160 may also rank the GPU kernels via the GPU kernel rank circuitry 425. GPU kernel ranking involves evaluating, comparing, and prioritizing different kernel implementations based on execution performance metrics for a given computation task. The GPU kernel rank circuitry 425 facilitates this process by dynamically scoring and ranking kernels in real-time. The GPU kernels can be sorted based on their computation scores. The highest-ranked GPU kernel is chosen for execution. If multiple computation tasks exist, the GPU kernel rank circuitry 425 ranks the GPU kernels across different workloads or computation tasks to ensure the most optimal execution strategy for the GPU pipeline.

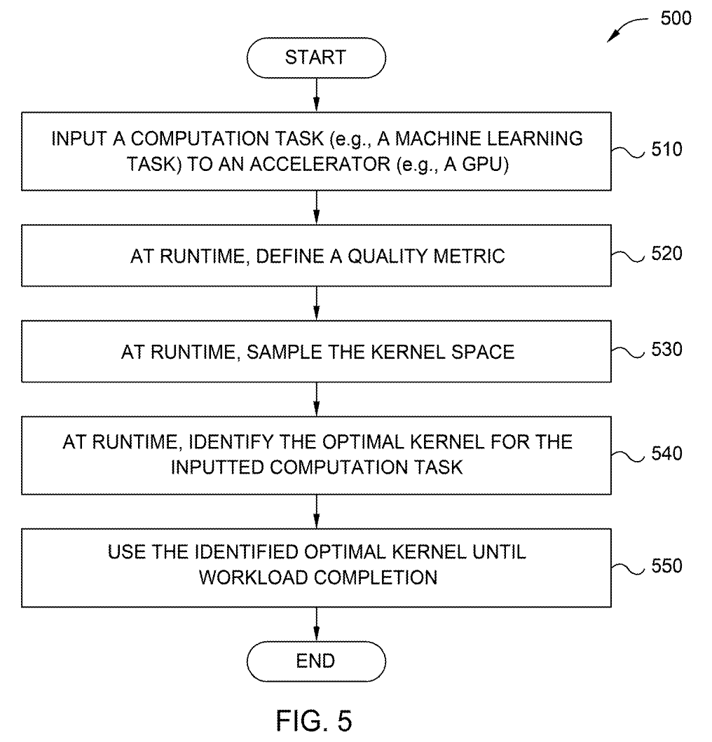

FIG. 5 illustrates a method for using the accelerator to select an optimal kernel solution, according to an example.

At 510, a computation task (e.g., a machine learning task) is input to an accelerator (e.g., a GPU). When a computation task is sent to the GPU accelerator, input data, execution parameters, and kernel configurations are transferred to the GPU memory. The task is divided into parallel workloads that are mapped to the GPU cores.

At 520, a quality metric is defined at runtime. Common quality metrics include execution time, throughput, memory usage, and energy consumption.

At 530, the kernel space is sampled at runtime. During runtime, various kernel configurations are sampled (e.g., thread/block sizes, memory usage strategies, synchronization methods) and their performance is evaluated based on the defined metrics. This may involve running a set of benchmarks or small samples of the kernel with different configurations and observing which configuration yields the best performance. For each kernel configuration, the performance against the defined metrics is measured. This involves monitoring how each configuration performs under varying conditions, including the size of the data set, hardware utilization, and resource constraints. Profiling data is used to assess each configuration’s performance and select the one that performs best based on the input workload.

At 540, the optimal kernel for the inputted computation task is identified at runtime. Based on the profiling data, the optimal configuration is selected for the given workload at that point in time. For example, if the workload includes large matrices, a configuration with larger thread blocks and tiled memory might be selected. If the workload is smaller, a smaller thread block and more efficient use of shared memory may be better.

At 550, the identified optimal kernel is used until workload completion. Once the optimal kernel configuration is selected, the kernel is launched using the selected configuration. The input workload is executed with this optimal kernel configuration for the entire duration of the workload. While the workload is executing, its performance may be continuously monitored to ensure that the selected kernel remains optimal under the current conditions. In case of changes (e.g., GPU thermal conditions fluctuate, available memory decreases, workload changes), the kernel configuration may be reassessed and adjusted if necessary. This can involve dynamically adjusting the configuration in response to runtime conditions.

In conclusion, the example three-step approach (i.e., definition of quality metric, sampling kernel space, and selection of kernel configuration for execution) addresses the challenges of selecting the optimal GPU kernel configuration for dynamic runtime conditions. By first defining a quality metric that quantifies the performance goals (e.g., execution time, memory utilization, throughput), the approach establishes a clear, objective benchmark for evaluating the various kernel configurations. This metric serves as a guide to understanding how different kernel variants perform under changing conditions and provides the basis for subsequent decisions. By aligning the kernel evaluation to a concrete performance metric, the process mitigates the unpredictability of runtime profiles and ensures that the system prioritizes the most relevant aspect of performance, whether it’s minimizing latency, optimizing power consumption, or maximizing throughput.

The second step, sampling the kernel space, allows the system to continuously gather real-time performance data for a wide range of possible kernel configurations during runtime. This dynamic profiling helps account for fluctuations in system conditions, such as changes in memory availability, thermal states, and resource contention, by testing and measuring the impact of each configuration in the actual execution environment. Unlike traditional ahead-of-time tuning, which may overlook runtime variability, sampling allows for the identification of the most effective kernel configuration based on the current workload and accelerator state. This ensures that the system isn't locked into a suboptimal configuration, but instead adapts based on real-world conditions that can significantly impact performance.

The third step, selecting the optimal kernel configuration for execution, takes the data from the profiling phase and applies it to make an informed decision. With a clear quality metric and an understanding of how each kernel performs in real-time, the system can choose the best configuration at any given moment. This reduces the risk of performance degradation due to mismatches between kernel configuration and hardware conditions, and ensures that resources are being utilized efficiently. As runtime conditions evolve, the system can re-sample the kernel space, continuously adapting to new workloads, thermal conditions, and available hardware resources to maintain peak performance.

Therefore, the three-step process enables the system to overcome the inherent challenges in dynamic kernel selection by providing a structured, data-driven approach that accounts for runtime variability. The three-step process ensures that the accelerator remains adaptable, optimizing performance in real-time based on actual execution conditions (i.e., during runtime). By using quality metrics, runtime profiling, and adaptive kernel selection, this approach significantly enhances performance, efficiency, and resource utilization, allowing the accelerator to deliver consistent results across a wide range of workloads and environmental conditions.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An accelerator comprising:
circuitry configured to, during runtime:
sample, using profiling circuitry, a kernel space including multiple kernels to evaluate the multiple kernels based on one or more quality metrics;
identify an optimal kernel from the multiple kernels in the kernel space; and
use the optimal kernel for a computation task.

2. The accelerator of claim 1, wherein the profiling circuitry is configured to monitor and analyze how the multiple kernels behave during execution of the computation task.

3. The accelerator of claim 1, wherein a first register is used to store the one or more quality metrics.

4. The accelerator of claim 3, wherein a second register is used to store per-kernel metrics for a kernel invocation pertaining to execution performance data.

5. The accelerator of claim 4, wherein a third register is used to store data pertaining to metrics results.

6. The accelerator of claim 1, wherein the one or more quality metrics include at least one of execution time, throughput, power consumption, memory usage, thread divergence, load balancing, and resource utilization.

7. The accelerator of claim 1, wherein the optimal kernel for the computation task is dynamically determined based on runtime performance metrics derived from the profiling circuitry.

8. The accelerator of claim 1, wherein kernel rank circuitry is used to rank the multiple kernels for the computation task.

9. The accelerator of claim 1, wherein the computation task is a machine learning task and the multiple kernels are graphics processing unit (GPU) kernels.

10. The accelerator of claim 1, wherein the accelerator is a GPU.

11. A processor comprising:
profiling circuitry configured to sample multiple kernels of a kernel space to evaluate the multiple kernels on runtime behavior based on one or more quality metrics; and
kernel selector circuitry configured to identify an optimal kernel from the multiple kernels.

12. The processor of claim 11, wherein the processor is a graphics processing unit (GPU).

13. The processor of claim 11, wherein a first register is used to store the one or more quality metrics and per-kernel metrics for a kernel invocation pertaining to execution performance data.

14. The processor of claim 13, wherein a second register is used to store data pertaining to metrics results.

15. The processor of claim 11, wherein the optimal kernel for a computation task is dynamically determined based on runtime performance metrics derived from the profiling circuitry.

16. The processor of claim 11, wherein kernel rank circuitry is used to rank the multiple kernels based on a computation task received by the processor.

17. The processor of claim 16, wherein the computation task is a machine learning task and the multiple kernels are graphics processing unit (GPU) kernels.

18. A method comprising:
providing a computation task to an accelerator;
sampling, during runtime, a kernel space including multiple kernels to evaluate the multiple kernels based on one or more quality metrics;
identifying an optimal kernel from the multiple kernels in the kernel space; and
using the optimal kernel for the computation task.

19. The method of claim 18, wherein multiple registers are used to store the one or more quality metrics, per-kernel metrics for a kernel invocation pertaining to execution performance data, and data pertaining metrics results.

20. The method of claim 18, wherein the computation task is a machine learning task and the multiple kernels are graphics processing unit (GPU) kernels.
